(19) United States
(12) Patent Application Publication
(10) Pub. No.: US 2005/0195756 A1
(43) Pub. Date: Sep. 8, 2005

(54) Status announcement system and method

(76) Inventor: David E. Frattura, New York, NY (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/066,608

(22) Filed: Feb. 25, 2005

Related U.S. Application Data
(60) Provisional application No. 60/547,946, filed on Feb. 26, 2004.
(60) Provisional application No. 60/552,323, filed on Mar. 11, 2004.

(51) Int. Cl. H04L 12/16

(52) U.S. Cl. 370/259

(57) ABSTRACT

A method includes establishing a network connection between an endpoint device and a network device within a data network. An announcement message is encoded to include at least one connection criteria. The announcement message is transmitted to the network device.

### RELATED APPLICATIONS

This application claims the priority of the following applications, which are herein incorporated by reference: U.S. Provisional Application Ser. No. 60/547,946, entitled, “Methods of Enhanced e911/Emergency Calling Services on a Data Communications Network”, filed 26 Feb. 2004; and U.S. Provisional Application Ser. No. 60/552,323, entitled, “Method of System Attribute Announcement and Enhanced Network Policy Service”, filed 11 Mar. 2004.

### FIELD OF THE DISCLOSURE

This disclosure relates to announcement messaging systems and methods and, more particularly, to network announcement messaging systems and methods.

### BACKGROUND

With the advent of Voice-over-Internet-Protocol (i.e., VoIP) telephony, it has become important that data networks be capable of efficiently handling time-sensitive voice traffic. The traditional approaches to ensuring the prioritization of telephony data over traditional network data are often based on the use of various “class of service” and “quality of service” techniques. The class of service/quality of service parameters are typically configured on the network relay devices to which the VoIP endpoint devices (e.g., telephones, handsets, videophones, etc.) are attached. Unfortunately, these configurations are typically static and do not adjust in response to the quantity of VoIP data being generated by the VoIP endpoint devices.

These problems are only compounded when considering emergency calls (e.g., 911 calls), as it is difficult to ensure that emergency calls are handled with a heightened level of urgency within the data network. Unfortunately, VoIP protocols (e.g., H.323 or Session Initiation Protocol) do not readily interact with the network devices through which they are transmitted and, therefore, it is currently difficult to assign a higher level of urgency to emergency calls.

### SUMMARY OF THE INVENTION

According to an aspect of this invention, a method includes establishing a network connection between an endpoint device and a network device within a data network. An announcement message is encoded to include at least one connection criteria. The announcement message is transmitted to the network device.

One or more of the following features may also be included. The endpoint device may be a VoIP telephony endpoint device. Encoding a message may include populating a message field within the announcement message with the at least one connection criteria. The at least one connection criteria may define a connection-type for the network connection. The message may be compliant with a transmission protocol (e.g., 802.1AB link layer discovery protocol). The announcement message received by the network device may be processed, and at least one traffic policy of the network device may be configured in accordance with the at least one connection criteria. The network device may be chosen from the group consisting of: a switching device; a routing device; a bridge; a gateway; an access point; a repeating device; a signal forwarding device; a packet forwarding device; and a server.

According to another aspect of this invention, an apparatus includes an integrated circuit, such that the integrated circuit is capable of establishing a network connection between an endpoint device and a network device within a data network. An announcement message is encoded to include at least one connection criteria. The announcement message is transmitted to the network device.

One or more of the following features may also be included. The endpoint device may be a VoIP telephony endpoint device. Encoding a message may include populating a message field within the announcement message with the at least one connection criteria. The at least one connection criteria may define a connection-type for the network connection. The message may be compliant with a transmission protocol (e.g., 802.1AB link layer discovery protocol). The announcement message received by the network device may be processed, and at least one traffic policy of the network device may be configured in accordance with the at least one connection criteria. The network device may be chosen from the group consisting of: a switching device; a routing device; a bridge; a gateway; an access point; a repeating device; a signal forwarding device; a packet forwarding device; and a server.

According to another aspect of this invention, a computer program product resides on a computer readable medium having a plurality of instructions stored thereon. When executed by the processor, the instructions cause that processor to establish a network connection between an endpoint device and a network device within a data network. An announcement message is encoded to include at least one connection criteria. The announcement message is transmitted to the network device.

One or more of the following features may also be included. The endpoint device may be a VoIP telephony endpoint device. Encoding a message may include populating a message field within the announcement message with the at least one connection criteria. The at least one connection criteria may define a connection-type for the network connection. The message may be compliant with a transmission protocol (e.g., 802.1AB link layer discovery protocol). The announcement message received by the network device may be processed, and at least one traffic policy of the network device may be configured in accordance with the at least one connection criteria. The network device may be chosen from the group consisting of: a switching device; a routing device; a bridge; a gateway; an access point; a repeating device; a signal forwarding device; a packet forwarding device; and a server.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a block diagram of a data network including a status transmission system and a status announcement system;

FIG. 2 is a more-detailed view of the status transmission system and the status announcement system of FIG. 1; and

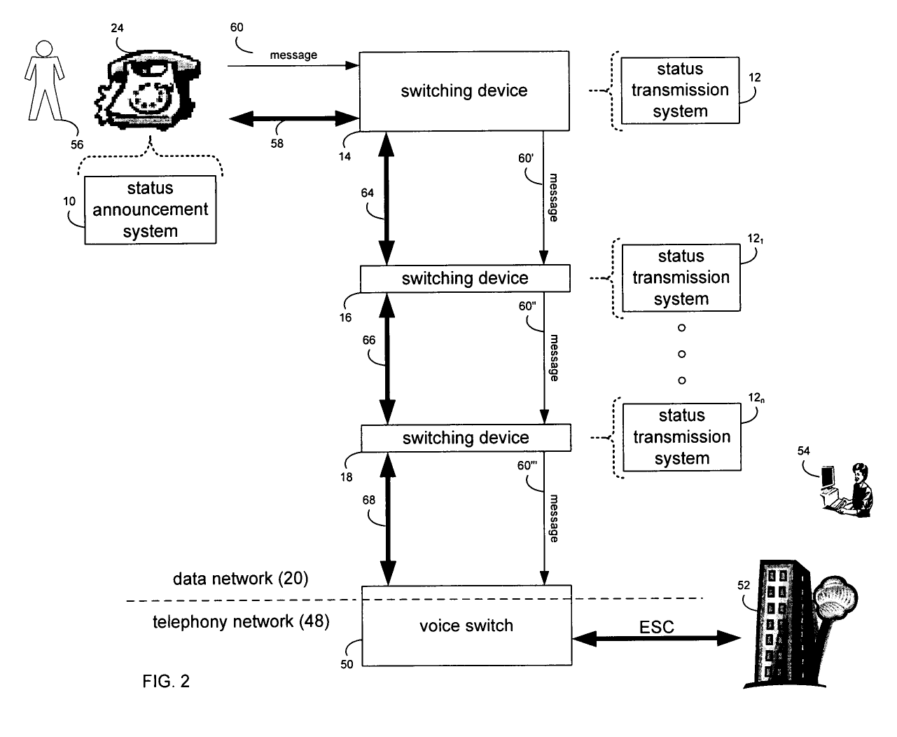

FIG. 3 is a flow chart of the status transmission system and the status announcement system of FIG. 1.

### DETAILED DESCRIPTION OF THE PREFERRED EMBODIMENTS

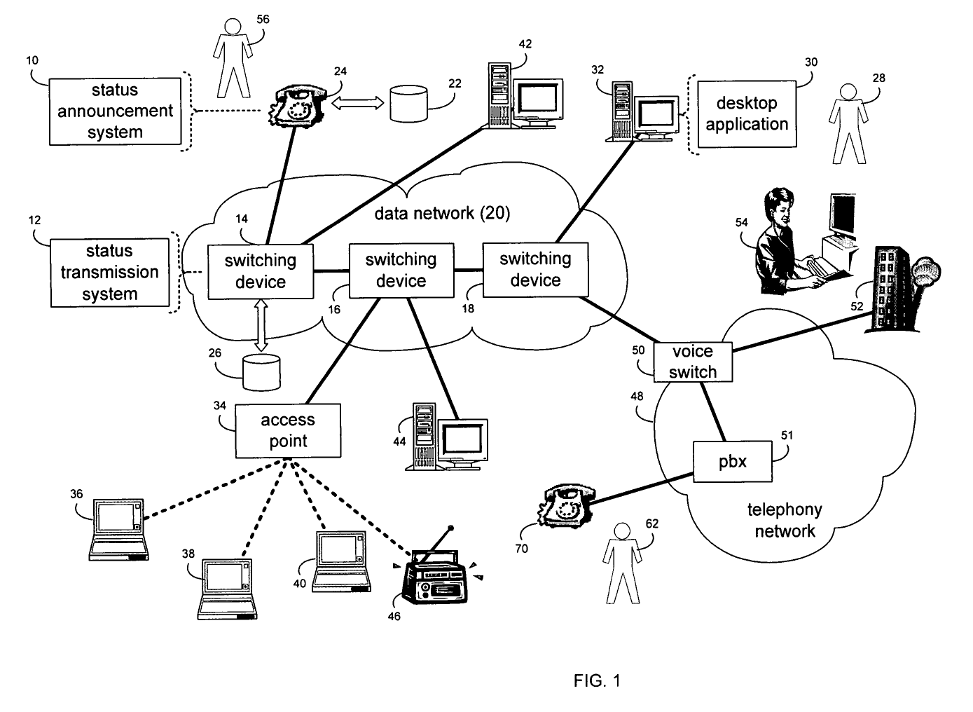

Referring to FIGS. 1 & 2, there is shown a status announcement system 10 and a status transmission system 12, each of which transmits messages to network devices (e.g., switching devices 14, 16, 18). A switching device is a device that examines each data packet to determine, from a physical address such as a MAC address, the intended recipient of the data packet.

Status announcement system 10 typically resides on and is executed by one or more endpoint devices (e.g., VoIP telephony endpoint device 24) connected to data network 20 (e.g., a local area network, an intranet, the internet, or some other form of network). The instruction sets and subroutines of status announcement system 10 are typically stored on a storage device 22 connected to one or more endpoint devices. Storage device 22 may be, for example, a hard disk drive, a tape drive, an optical drive, a RAID array, a random access memory (RAM), or a read-only memory (ROM). Alternatively or additionally, status announcement system 10 may be embodied within an integrated circuit incorporated into one or more endpoint devices.

Status transmission system 12 typically resides on and is executed by one or more network devices (e.g., switching device 14) connected to data network 20. As status transmission system 12 may be resident on multiple network devices, multiple instances of status transmission system 12 are represented as status transmission system 121 and status transmission system 12ₙ. The instruction sets and subroutines of status transmission system 12 are typically stored on a storage device 26 connected to the one or more network devices. Storage device 26 may be, for example, a hard disk drive, a tape drive, an optical drive, a RAID array, a random access memory (RAM), or a read-only memory (ROM). Alternatively or additionally, status transmission system 12 may be embodied within an integrated circuit incorporated into one or more network devices.

A network administrator 28 typically configures, accesses, and administers status announcement system 10 and/or status transmission system 12 through a desktop application 30 (e.g., Microsoft Internet Explorer™, Netscape Navigator™, SNMP-based (i.e., Simple Network Management Protocol) management tool or a specialized user interface) running on a computer 32 that is also connected to data network 20.

Various network devices may be included within data network 20, such as: a wireless access point (WAP) 34 (i.e., a device that allows for wireless communication of data between access point 34 and one or more computing devices 36, 38, 40); and computers 42, 44, for example. Additional devices include routing devices (not shown); gateway devices (not shown); bridges (not shown), Intrusion Detection Systems (not shown), Intrusion Prevention Systems (not shown), repeaters (not shown), signal forwarding devices (not shown), packet forwarding devices (not shown), attached functions (not shown), and end systems (not shown). Additionally, non-traditional computing devices, such as IP radios 46, may also be connected to data network 20.

Data network 20 may be coupled to a telephone network 48 through a voice switch 50 that converts the packetized data used in VoIP telephone calls to the analog data traditionally used in telephone networks.

Telephone network 48 may include PBX 51 (i.e., private branch exchange), which is a private telephone network used within an enterprise (e.g., an office building). Telephone network 48 may also include a PSAP 52 (i.e., Public Safety Answering Point) that receives emergency telephone calls and routs them to the proper emergency services provider (e.g., fire, police, and ambulance, for example). PSAP 52 is typically staffed by operator 54. An example of PSAP 52 is (in the United States of America) the 911 Emergency Dispatch System.

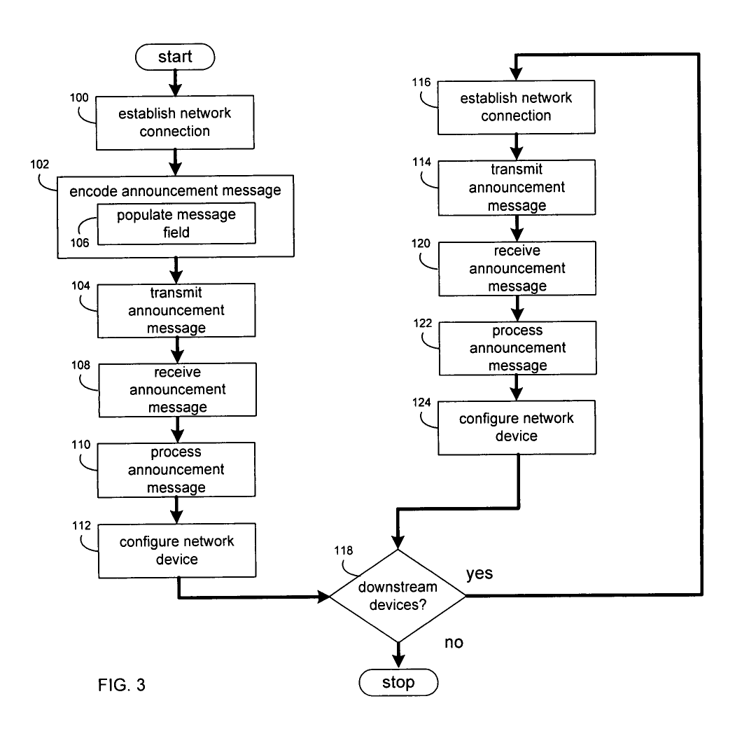

Referring also to FIG. 3 and as discussed above, status announcement system 10 typically resides on and is executed by VoIP telephony endpoint device 24. Examples of VoIP telephony endpoint device 24 include: VoIP telephones; VoIP handsets; hybrid computer/VoIP devices; and VoIP video phones, for example.

When user 56 uses VoIP telephony endpoint device 24 to initiate a voice telephone call, VoIP telephony endpoint device 24 establishes 100 a network connection 58 between switching device 14 and VoIP telephony endpoint device 24. Announcement system 10 encodes 102 an announcement message 60 that is transmitted 104 to switching device 14. Announcement message 60 includes one or more connection criteria (not shown), which typically define the status of the VoIP telephone call.

As discussed above, it is desirable to assign a higher level of priority to VoIP data (as opposed to standard network data), due to the high level of sensitivity that VoIP data has to time delays and packet loss. Accordingly, by announcement message 60 defining the connection 58 between VoIP telephony endpoint device 24 and switching device 14 as a VoIP connection, higher priority will be given to the processing of packets received on the port (not shown) on switching device 14 to which connection 58 is established.

Typically, the encoding 102 and transmission 104 of announcement message 60 is accomplished via a neighbor discovery protocol, such as The Institute of Electrical and Electronics Engineers 802.1ab LLDP (i.e., Link Layer Discovery Protocol).

LLDP defines a standard method for network devices (e.g., switching devices 14, 16, 18, and wireless access point 34) to advertise information about themselves (via announcement messages) to other network devices and to store the information they receive from other network devices. Accordingly, device details (e.g., device configuration, device capabilities, and device identification) can be advertised using LLDP.

Specifically, LLDP defines: a set of common announcement messages; a protocol for transmitting the announcement messages to network devices; and a method for storing the information contained within the announcement messages received from other network devices.

Accordingly and assuming that LLDP is utilized, when user 56 uses VoIP telephony endpoint device 24 to initiate a voice telephone call, announcement system 10 encodes 102 an announcement message 60 that is transmitted 104 to switching device 14. Announcement message 60 (in this example) is an LLDP formatted announcement message that includes a type length value (TLV) field that is modified by announcement system 10 to include a description of the type of voice telephone call being placed. For example, if user 58 is calling her friend 62, as this is a non-emergency call, the TLV field within message 60 will be populated 106 to include the connection criteria “VoIP telephone call”. This message 60 is then transmitted 104 to switching device 14. Upon receipt 108 of message 60 by switching device 14, message 60 is processed 110 to extract the connection criteria, which in the example is “VoIP telephone call”. Switching device 14 will then configure 112 one or more traffic policies in accordance with this connection criteria. For example, switching device 14 may dynamically configure the buffer queues, the queue scheduler algorithm, and the traffic shaping functions (of switching device 14) to ensure that the bandwidth required is available (to connection 58) to ensure the viability of the VoIP telephone call.

In addition to connection criteria that broadly identifies the telephone call as a “VoIP telephone call”, VoIP telephony endpoint device 24 is typically also capable of encoding and transmitting the following announcement messages:

Telephony Endpoint Status Announcement Message: This announcement message provides the status of the telephony endpoint itself (e.g., VoIP telephony endpoint device 24). A telephony endpoint status announcement message can indicate the following status information:
a. Contact has been made to a telephony controller system (e.g., a soft switch, Internet Protocol PBX, or SIP Proxy, for example);
b. The telephony endpoint is functional and capable of establishing telephony sessions;
c. The telephony endpoint has been rejected by a telephony controller system and is not capable of establishing telephony sessions; and
d. The telephony endpoint is experiencing/has experienced an error condition and may not be capable of functioning properly

Telephony Session Announcement Message: This announcement message indicates how many telephony sessions the telephony endpoint is currently participating in.

Telephony Session Status Announcement Message: This announcement message indicates the status of each telephony session that the telephony endpoint is currently participating in. Each telephony session announcement message may include a session identifier that provides a unique identity for a particular telephony session when the telephony endpoint is participating in multiple telephony sessions. A telephony session status announcement message may indicate the following status information:
a. That telephony session is being established (dialing) from this telephony endpoint to another telephony endpoint;
b. That a telephony session has been established but is currently on hold;
c. That a telephony session is ending (i.e., hanging-up); and
d. That protocol errors have occurred while establishing the telephony session.

Telephony Session Destination Data Link Layer Address Announcement Message: This announcement message makes known the OSI Model Layer 2 “Data Link Layer (MAC)” address of the destination telephony endpoint in a particular telephony session. In applications where the telephony endpoint is participating in more than one telephony session, a session identifier may be included in the announcement message.

Telephony Session Destination Network Layer (Internet Protocol or other type) Address Announcement Message: This announcement message makes known the OSI Model Layer 3 “Network Layer” address of the destination telephony endpoint in a particular telephony session. In applications where the telephony endpoint is participating in more than one telephony session, a session identifier may be included in the announcement message.

Telephony Session Destination Calling Number Announcement Message: This announcement message makes known the telephony calling number of the destination endpoint in a particular telephony session. In applications where the telephony endpoint is participating in more than one telephony session, a session identifier may be included in the announcement message.

Telephony Session Destination Endpoint Name Announcement Message: This announcement message makes known the name of the destination telephony endpoint in a particular telephony session. In applications where the telephony endpoint is participating in more than one telephony session, a session identifier can be included in the announcement message.

CODEC in use for Transmitted Session Announcement Message: This announcement makes known the CODEC technology being used for a telephony session that is being transmitted from the telephony endpoint to a data network relay device (e.g., switching device 14). An example of such a CODEC may include the International Telecommunication Union G711 CODEC. In applications where the telephony endpoint is participating in more than one telephony session, a session identifier may be included in the announcement message.

Transmitted Telephony Session Bandwidth Announcement Message: This announcement message makes known the bandwidth (e.g., in kilobits per second or megabits per second, for example) being transmitted into the network relay device (e.g., switching device 14) by the telephony endpoint for a telephony session. In applications where the telephony endpoint is participating in more than one telephony session, a session identifier may be included in the announcement message.

Total Bandwidth Transmitted for all Sessions Announcement Message: This announcement message makes known the total bandwidth (i.e., the sum of all sessions) being transmitted into the network relay device (e.g., switching device 14) by the telephony endpoint. This announcement message may be in kilobits per second, or megabits per second, for example.

CODEC in use for Received Session Announcement Message: This announcement message makes known the CODEC technology being used for a telephony session that is being received by the telephony endpoint from the data network relay device (e.g., switching device 14). An example of such a CODEC may include the International Telecommunication Union G711 CODEC. In applications where the telephony endpoint is participating in more than one telephony session, a session identifier may be included in the announcement message.

Received Telephony Session Bandwidth Announcement Message: This announcement message makes known the bandwidth (e.g., in kilobits per second or megabits per second, for example) being received by the telephony endpoint for the telephony session. In applications where the telephony endpoint is participating in more than one telephony session, a session identifier may be included in the announcement message.

Total Bandwidth Received for all Sessions Announcement Message: This announcement message makes known the total bandwidth (e.g., in kilobits per second or megabits per second, for example) that will be received by the telephony endpoint for all telephony sessions it is currently participating in.

Telephony Session Quality Status Announcement Message: This announcement message allows a telephony endpoint to announce to the data network relay device (e.g., switching device 14) the quality of the specific session between the two telephony endpoints participating in the session. In applications where the telephony endpoint is participating in more than one telephony session, a session identifier may be included in the announcement message.

Transmission Control Protocol Source and Destination Port Pair Value Announcement Message: This announcement message makes known the transmission control protocol source and destination port values associated with a telephony session. In applications where the telephony endpoint is participating in more than one telephony session, a session identifier may be included in the announcement message.

User Datagram Protocol Source and Destination Port Pair Value Announcement Message: This announcement message makes known the user datagram protocol source and destination port values associated with a telephony session. In applications where the telephony endpoint is participating in more than one telephony session, a session identifier may be included in the announcement message.

Telephony Endpoint Password Announcement Message: This announcement message provides a method by which a network relay device (e.g., switching device 14) can make a trust association with a telephony endpoint. A simple text-string password, a message digest string, a digital certificate, or other types of identity verification mechanism may be used with this announcement message. This announcement message is intended to allow a telephony endpoint to authenticate itself and prove (to e.g., switching device 14) that the telephony endpoint is actually a verified telephony endpoint.

Once announcement message 60 is received 108 by switching device 14, switching device 14 may transmit 114 the received announcement message 60 to a downstream network device (e.g., switching devices 16).

For example, upon switching device 14 receiving announcement message 60 from VoIP telephony endpoint device 24, switching device 14 may establish 116 a network connection 64 between switching device 14 and switching device 16. Additionally, switching device 14 may transmit 114 announcement message 60′ to the downstream network device (e.g., switching device 16), thus providing the downstream network device with the connection criteria originally encoded within announcement message 60. Announcement message 60′ may simply be a retransmission of original announcement message 60, or may be appended/modified to include additional information pertinent to e.g., the network device transmitting announcement message 60′.

The process of establishing 116 network connections and transmitting 114 announcement messages in repeated until telephony network 48 is accessed. For example, each time a connection is established 116 and a message is transmitted 114, a determination 118 is made concerning whether additional downstream network devices need to be notified. If additional downstream network devices are present (and, therefore, telephony network 48 is not yet accessed), the establishing and transmitting process is repeated.

For example, upon receiving 120 announcement message 60′ from switching device 14, switching device 16 processes 122 announcement message 60′ to extract the connection criteria, which in the example is “VoIP telephone call”. Switching device 16 will then configure 124 one or more traffic policies of switching device 16 in accordance with this connection criteria. A determination is made that a downstream network device (i.e., switching device 18) needs to be notified. Accordingly, switching device 16 may establish 116 a network connection 66 between switching device 16 and switching device 18, and may transmit 114 announcement message 60″ to switching device 18.

Further, upon receiving 120 announcement message 60″ from switching device 16, switching device 18 processes 122 announcement message 60″ to extract the connection criteria, which in the example is “VoIP telephone call”. Switching device 18 will then configure 124 one or more traffic policies of switching device 18 in accordance with this connection criteria. A determination is made that a downstream network device (i.e., voice switch 50) needs to be notified. Accordingly, switching device 18 may establish 116 a network connection 68 between switching device 18 and voice switch 50, and may transmit 114 announcement message 60′″ to voice switch 50.

Additionally, upon receiving 120 announcement message 60′″ from switching device 18, voice switch 50 processes 122 announcement message 60′″ to extract the connection criteria, which in the example is “VoIP telephone call”. Voice switch 50 will then configure 124 one or more traffic policies of voice switch 50 in accordance with this connection criteria. A determination is made that no additional downstream network devices need to be notified, as telephony network 48 has been accessed. The VoIP telephone called is subsequently routed to PBX 51 and (ultimately) telephone 70 (i.e., the telephone used by the recipient of the VoIP telephone call initiated by user 56).

Accordingly, by transmitting the connection criteria throughout data network 20 (via announcement messages 60, 60′, 60″ and 60′″), all devices between VoIP telephony endpoint device 24 and telephone 70 may be configured to provide a higher level of priority to VoIP data.

As discussed above, it is desirable to assign a higher level of priority to VoIP data (as opposed to standard network data), due to the high level of sensitivity that VoIP data has to time delays and packet loss. Further, it is desirable to apply an even higher level of priority to VoIP data (as opposed to standard network data) when the VoIP data is actually an emergency call (e.g., a 911 call in the United States of America).

Accordingly, assume that user 56 is having chest pains and uses VoIP telephony endpoint device 24 to dial “911”, which needs to be routed to PSAP 52 and (ultimately) to operator 54. As discussed above, VoIP telephony endpoint device 24 establishes 100 a network connection 58 between switching device 14 and VoIP telephony endpoint device 24. Announcement system 10 encodes 102 announcement message 60, which is transmitted 104 to switching device 14. However, unlike when user 56 was calling friend 62 and the TLV field within message 60 was populated 106 to include the connection criteria “VoIP telephone call”, the TLV field will now be populated 106 to include the connection criteria “Emergency Call in Progress”.

Upon receipt 108 of message 60 by switching device 14, message 60 is processed 110 to extract the connection criteria, which in this example is “Emergency Call in Progress”. Switching device 14 will then configure 112 one or more traffic policies in accordance with this connection criteria. As discussed above, switching device 14 may dynamically configure the buffer queues, the queue scheduler algorithm, and the traffic shaping functions (of switching device 14) to ensure that the bandwidth required is available to connection 58 to ensure the viability of the VoIP telephone call. Further, as this is an emergency call, more drastic measures may be taken, such as defining that the emergency call (while active) has a mandatory minimum bandwidth (e.g., 128 kilobits per second), even if this mandatory minimum bandwidth occurs at the expense of other standard network data connections and/or other non-emergency VoIP connections.

In addition to connection criteria that broadly identifies the telephone call as a “Emergency Call in Progress”, VoIP telephony endpoint device 24 is typically also capable of encoding and transmitting the following emergency announcement messages: (a) the destination data link layer address for the voice switch (e.g., voice switch 50) and/or the PBX (e.g., PBX 51) that is needed to reach PSAP 52; (b) the destination network layer address for the voice switch (e.g., voice switch 50) and/or the PBX (e.g., PBX 51) that is needed to reach PSAP 52; (c) the status of the emergency service call; (d) the E911 location identification number (as defined by ANSI specification T1.628.200); (e) E911 geographic location coordinates (as defined by ANSI specification T1.628.200); and/or (f) the network address of the voice endpoint making the emergency call.

Upon switching device 14 receiving announcement message 60 from VoIP telephony endpoint device 24, switching device 14 may establish 116 a network connection 64 between switching device 14 and switching device 16. Additionally, switching device 14 may transmit 114 announcement message 60′ to the downstream network device (e.g., switching device 16), thus providing the downstream network device with the connection criteria originally encoded within announcement message 60. Announcement message 60′ may simply be a retransmission of original announcement message 60, or may be appended/modified to include additional information pertinent to e.g., the network device transmitting announcement message 60′.

Upon receiving 120 announcement message 60′ from switching device 14, switching device 16 processes 122 announcement message 60′ to extract the connection criteria, which in the example is “Emergency Call in Progress”. Switching device 16 will then configure 124 one or more traffic policies of switching device 16 in accordance with this connection criteria. A determination is made that a downstream network device (i.e., switching device 18) needs to be notified. Accordingly, switching device 16 may establish 116 a network connection 66 between switching device 16 and switching device 18, and may transmit 114 announcement message 60″ to switching device 18.

Further, upon receiving 120 announcement message 60″ from switching device 16, switching device 18 processes 122 announcement message 60″ to extract the connection criteria, which in the example is “Emergency Call in Progress”. Switching device 18 will then configure 124 one or more traffic policies of switching device 18 in accordance with this connection criteria. A determination is made that a downstream network device (i.e., voice switch 50) needs to be notified. Accordingly, switching device 18 may establish 116 a network connection 68 between switching device 18 and voice switch 50, and may transmit 114 announcement message 60′″ to voice switch 50.

Additionally, upon receiving 120 announcement message 60′″ from switching device 18, voice switch 50 processes 122 announcement message 60′″ to extract the connection criteria, which in the example is “Emergency Call in Progress”. Voice switch 50 will then configure 124 one or more traffic policies of voice switch 50 in accordance with this connection criteria. A determination is made that no additional downstream network devices need to be notified, as telephony network 48 has been accessed. The VoIP telephone called is subsequently routed to PSAP 52 and (ultimately) operator 54.

Accordingly, by transmitting the “Emergency Call in Progress” connection criteria throughout data network 20 (via announcement messages 60, 60′, 60″ and 60′″), all devices between VoIP telephony endpoint device 24 and PSAP 52 may be configured to provide a higher level of priority to the “Emergency Call in Progress” VoIP data.

While the system is described above as dynamically configuring the buffer queues, the queue scheduler algorithm, and the traffic shaping functions in accordance with the connection criteria, other policies may also be configured. For example, other configurable policies include:

Filter Policy: This policy provides the system with the ability to filter messages. This Filter action may be pre-defined or dynamically created and may be applied to single or multiple interfaces.

Access Control List Creation Policy: This Policy creates a router access control list that is used to “filter” communications messages transiting through a routing system.

Route Map Policy: This policy defines a route map for a specific traffic type. A policy route map directs traffic out of specific interfaces regardless of what would normally occur during the normal operation of a device. In a routing device, a route map policy would forward communications messages to an interface other than the ones expected to be used as calculated by the dynamic routing protocol.

VLAN Containment Policy: This policy would provision a network ingress device to map all traffic matching a set of characteristics. This policy is useful in that it could map all traffic from a source to a specific or specialized network.

802.1X Un-Authenticate/Virtual Port Close Policy: This policy would provision a system to un-authenticate a previously authorized connection. This policy would “close the virtual port” associated with the 802.1X authenticator process existing in the communications device. This policy would effectively filter all traffic that ingresses into the communications system for the port or ports where this policy is being provisioned.

802.11 Disassociate Policy: This policy would instruct a wireless access point to disassociate a particular 802.11 client function from a particular access point of channel frequency. This policy would effectively disconnect a wireless client from the communications network.

802.11 Associate Channel Only Policy: This policy would instruct an 802.11 or wireless infrastructure to only allow a particular wireless client function to only associate (allow to connect) to a specified channel frequency. This policy would allow a wireless network to steer a wireless client function to a specific network.

Bandwidth Rate Shape/Limit Bandwidth Policy: This policy would enable a mechanism that limits the amount of bandwidth over a period of time (shape) or to a peak value (limit). The Analysis Function can specify bandwidth levels dynamically.

Traffic Surveillance Policy: This policy would enable the network system to “mirror” traffic to a monitor port for further forensic analysis by additional functions. A mirror or surveillance function is a mechanism to replicate communications messages to an additional interface or external system for additional analysis while still allowing it to be forwarded through the normal interface that would be configured for normal operation.

Flow Creation Rate Dampening Policy: This policy affects systems that are aware of communications flows. A Flow is a logical representation of a conversation between two or more systems on the communications network. Abasic flow is tracked as a conversation between two OSI Layer 2 or Layer 3 addresses or simply between two or more ports. A Flow Creation Rate Dampening policy would limit the creation rate of new flows from a particular source, or to a specific destination, or based on certain characteristics such as TCP or UDP port number.

Maximum Flows Allowed Policy: This policy would limit the number of Flows to a system, from a system or between systems based on characteristics such as TCP/UDP port number as provisioned by the Analysis Function.

While the system is described above as processing VoIP telephone calls, other configurations are possible. For example, the above-described system may be utilized whenever the data stream is time sensitive. For example, while delays in loading web pages are acceptable, delays in video streams and/or audio streams often result in fractured playback. Therefore, the above-described system may be utilized to prioritize the processing of all streaming data (as opposed to only VoIP data).

A number of implementations have been described. Nevertheless, it will be understood that various modifications may be made. Accordingly, other implementations are within the scope of the following claims.

1. A method comprising:
establishing a network connection between an endpoint device and a network device within a data network;
encoding an announcement message that includes at least one connection criteria; and
transmitting the announcement message to the network device.

2. The method of claim 1 wherein the endpoint device is a VoIP telephony endpoint device.

3. The method of claim 1 wherein encoding an announcement message includes:
populating a message field within the announcement message with the at least one connection criteria, wherein the at least one connection criteria defines a connection-type for the network connection.

4. The method of claim 1 wherein the message is compliant with a transmission protocol.

5. The method of claim 4 wherein the transmission protocol is an 802.1AB link layer discovery protocol.

6. The method of claim 1 further comprising:
processing the announcement message received by the network device; and
configuring at least one traffic policy of the network device in accordance with the at least one connection criteria.

7. The method of claim 1 wherein the network device is chosen from the group consisting of: a switching device; a routing device; a bridge; a gateway; an access point; a repeating device; a signal forwarding device; a packet forwarding device; and a server.

8. An apparatus comprising an integrated circuit, wherein the integrated circuit is capable of:
establishing a network connection between an endpoint device and a network device within a data network;
encoding an announcement message that includes at least one connection criteria; and
transmitting the announcement message to the network device.

9. The apparatus of claim 8 wherein the endpoint device is a VoIP telephony endpoint device.

10. The apparatus of claim 8 wherein encoding an announcement message includes:
populating a message field within the announcement message with the at least one connection criteria, wherein the at least one connection criteria defines a connection-type for the network connection.

11. The apparatus of claim 8 wherein the message is compliant with a transmission protocol.

12. The apparatus of claim 11 wherein the transmission protocol is an 802.1AB link layer discovery protocol.

13. The apparatus of claim 8 wherein the integrated circuit is further capable of:
processing the announcement message received by the network device; and
configuring at least one traffic policy of the network device in accordance with the at least one connection criteria.

14. The apparatus of claim 8 wherein the network device is chosen from the group consisting of: a switching device; a routing device; a bridge; a gateway; an access point; a repeating device; a signal forwarding device; a packet forwarding device; and a server.

15. A computer program product residing on a computer readable medium having a plurality of instructions stored thereon which, when executed by the processor, cause that processor to:
establish a network connection between an endpoint device and a network device within a data network;
encode an announcement message that includes at least one connection criteria; and
transmit the announcement message to the network device.

16. The computer program product of claim 15 wherein the endpoint device is a VoIP telephony endpoint device.

17. The computer program product of claim 15 wherein the instructions for encoding an announcement message include instructions for:
populating a message field within the announcement message with the at least one connection criteria, wherein the at least one connection criteria defines a connection-type for the network connection.

18. The computer program product of claim 15 wherein the message is compliant with a transmission protocol.

19. The computer program product of claim 15 wherein the transmission protocol is an 802.1AB link layer discovery protocol.

20. The computer program product of claim 15 further comprising instructions for:
processing the announcement message received by the network device; and
configuring at least one traffic policy of the network device in accordance with the at least one connection criteria.

21. The computer program product of claim 15 wherein the network device is chosen from the group consisting of: a switching device; a routing device; a bridge; a gateway; an access point; a repeating device; a signal forwarding device; a packet forwarding device; and a server.
